(19) United States
(12) Patent Application Publication
(10) Pub. No.: US 2014/0065400 A1
(43) Pub. Date: Mar. 6, 2014

(54) ELECTRICALLY CONDUCTIVE POLYMER COMPOSITIONS AND FILMS

(71) Applicant: Eastman Chemical Company, Kingsport, TN (US)

(72) Inventors: Anietie lyaibuk Essiet, Spencer, VA (US); Anthony Brian Port, Collinsville, VA (US)

(73) Assignee: Eastman Chemical Company, Kingsport, TN (US)

(21) Appl. No.: 13/975,653

(22) Filed: Aug. 26, 2013

Related U.S. Application Data
(60) Provisional application No. 61/694,570, filed on Aug. 29, 2012.

(51) Int. Cl. H01B 1/20

(52) U.S. Cl. CPC H01B 1/20
USPC 428/220; 252/500; 427/508

(57) ABSTRACT

Electrically conductive polymer compositions are described herein that can be used to produce coatings and films for use in electronic devices. The electrically conductive polymer compositions generally comprise an intrinsically conductive polymer, a UV curable resin, at least one solvent, and a photoinitiator. The coatings and films produced from the electrically conductive polymer compositions can exhibit superior wettability, superior solvent resistance, high levels of visible light transmission, low levels of haze, and ideal electrical resistivity.

### RELATED APPLICATIONS

This application claims the priority benefit under 35 U.S.C. §119(e) of U.S. Provisional Patent Application Ser. No. 61/694,570 entitled “Electrically Conductive Polymer Compositions and Films,” filed Aug. 29, 2012, the entire disclosure of which is incorporated herein by reference.

### BACKGROUND

1. Field of the Invention

The present invention relates generally to electrically conductive polymer compositions and their uses in coatings, films, and electronic devices. More particularly, the present invention relates generally to electrically conductive polymer compositions containing an electrically conductive polymer and a UV curable resin.

2. Description of the Related Art

It is well known that a variety of electronic devices often utilize conductive coatings and films in their construction. Such electronic devices can include, for example, electroluminescent devices, electronic paper, batteries, fuel cells, energy-efficient lighting, solar panels, and other lighting display devices (e.g., organic light emitting diodes (“OLED”), LCDs, and touchscreen devices). The conductive coatings and films can provide multiple functions in these electronic devices. For example, the conductive coatings and films can act as a transparent screen and allow light to pass through to the active material beneath it, where carrier generation occurs. The conductive coatings and films can also function as an ohmic contact for carrier transport out of the active material and/or as a conductive or electrode layer in touchscreens and various other electronic displays. As such, conductive coatings and films often require a high visible light transmission, low haze, high durability, and a wide range of resistances.

Some of the most commonly utilized conductive coatings and films are constructed from transparent conducting oxides (“TCOs”), with indium tin oxide (“ITO”) being one of the most commonly utilized metal oxides. TCOs, however, have a number of drawbacks and limitations. First, TCOs are very expensive due to the high costs of the vacuum sputtering required for TCOs and the variable supply of the metals from which the TCOs are constructed. Second, ITO, the most common TCO, has a slightly yellow color, which is generally undesirable for consumers in many applications. Third, TCOs are very rigid and brittle, which makes them susceptible to cracking. Such characteristics are particularly concerning for flexible and touchscreen displays. Finally, TCOs generally have a very limited range of resistances, for example, on the order of about 15 Ω/square to 500 Ω/square.

Because of all the drawbacks and issues associated with TCOs, those in the conductive coatings and films industry have begun to look for alternatives to TCOs. Transparent conductive polymers (“TCPs”), such as polyaniline (“PANI”) and poly(3,4-ethylenedioxythiophene)-poly(styrenesulfonate) (“PEDOT-PSS”) have emerged as potential alternatives and replacements for TCOs in some applications. The TCP coatings and films can be more cost effective than TCOs since processing occurs via atmospheric roll-to-roll coating as opposed to vacuum sputtering. Additionally, due to their polymer-based composition, the TCP coatings and films are much more flexible and bendable, allowing for easier use in the growing field of touchscreens and flexible display devices.

Despite the aforementioned advantages of TCPs, they have had limited adoption in the conductive coatings and films industry because of several limitations associated with their use and construction. Although TCPs are generally less expensive than TCOs, TCPs are far less conductive than TCOs. As a result, in order for the TCP coatings and films to reach the desired lower resistivity values (e.g., 100 to 300 Ω/square), the applied costs for TCP coatings and films end up being close to those made from TCOs. Moreover, the currently utilized TCP films have higher hazes, lower visible light transmissions, and exhibit lower resistances to light, heat, humidity, and commonly used chemicals such as, for example, alcohols, water, soaps, and organic solvents. Accordingly, there is a need in the art for improved electrically conductive polymer compositions and associated films therefrom.

### SUMMARY

In one or more embodiments, the present invention concerns a film formed from an electrically conductive composition. The electrically conductive composition generally comprises an intrinsically conductive polymer; a UV curable resin; and a photoinitiator. The film exhibits a resistivity of less than 3,000 Ω/square and exhibits a change in resistance of less than 10% after being subjected to a solvent abrasion test according to AATCC Test Method 165.

In one or more embodiments, the present invention concerns an electrically conductive composition. The electrically conductive composition generally comprises at least 0.1 and not more than 10 mass percent of an intrinsically conductive polymer on a dry basis; at least 10 and not more than 80 mass percent of at least one solvent; at least 1 and not more than 20 mass percent of a UV curable resin; and a photoinitiator.

In one or more embodiments, the present invention concerns a film formed from an electrically conductive composition. The electrically conductive composition generally comprises an intrinsically conductive polymer; a UV curable resin; and a photoinitiator. The electrically conductive composition has a Monomer-Polymer Ratio of at least about 5:1 and not more than about 50:1. The film exhibits a resistivity of at least 100 and not more than 100,000 Ω/square.

In one or more embodiments, the present invention concerns a method for forming a film on a substrate. The method comprises (a) applying an electrically conductive composition on the substrate to form an initial coating; and (b) curing at least a portion of the initial coating to form the film on the substrate. The electrically conductive composition comprises an intrinsically conductive polymer, at least one solvent, a UV curable resin, a photoinitiator, and a Monomer-Polymer Ratio of at least about 5:1 and not more than about 50:1. Furthermore, the film exhibits a resistivity of at least 100 and not more than 100,000 Ω/square.

### DETAILED DESCRIPTION

The present invention is generally directed to electrically conductive polymer compositions and the transparent films produced therefrom, which can exhibit significantly improved wettability and resistance to chemicals such as alcohols, water, soaps, and organic solvents. Additionally, the transparent films and coatings described herein can exhibit high levels of visible light transmission, low levels of haze, and low levels of electrical resistivity. In various embodiments described herein, these advantageous properties can be obtained by producing films and coatings from an electrically conductive polymer composition comprising an intrinsically conductive polymer, a UV curable resin, at least one solvent, and a photoinitiator.

### Intrinsically Conductive Polymer

The electrically conductive polymer compositions described herein can comprise at least one intrinsically conductive polymer. As used herein, the term “polymer” refers to a material having at least one repeating monomeric unit, including homopolymers and copolymers. The term “intrinsically conductive” refers to a material that is capable of being electrically conductive without the addition of carbon black or conductive metal particles. In various embodiments, the intrinsically conductive polymer can have a conductivity of at least about 10, 25, or 75 and/or not more than about 500, 300, or 150 Siemens/cm. More particularly, the intrinsically conductive polymer can have a conductivity in the range of about 10 to 500, 25 to 300, or 75 to 150 Siemens/cm. In certain embodiments, the intrinsically conductive polymer can have a conductivity of about 100 Siemens/cm and are capable of forming thin films or coatings having a sheet resistivity of less than 3,000Ω per square.

The use of the intrinsically conductive polymers described herein can provide films and coatings that exhibit the desired levels of resistivity. In various embodiments, the intrinsically conductive polymers can comprise linear-backbone conjugated polymers including, for example, polythiophenes, polyacetylenes, polypyrroles, polyanilines, and combinations thereof. Examples of specific intrinsically conductive polymers include, for example, poly(p-phenylene vinylene); poly(3,4-ethylenedioxythiophene); polyaniline; polyacetylene; and poly(3,4-ethylenedioxythiophene)-poly(styrenesulfonate) (“PEDOT-PSS”).

As discussed further below, the electrically conductive polymer compositions can be in the form of a “wet composition” or a “dried composition.” As used herein, the “wet composition” refers to the composition prior to drying or curing when it contains at least one solvent. In contrast, the “dried composition” refers to the composition once it has been subjected to some form of curing and/or drying and wherein all or essentially all of the solvent has been evaporated therefrom. It should be noted that the dried composition may also be referred to as a “film” or “coating” depending on how the composition is cured or dried. Thus, any of the disclosure herein related to the dried composition can also be applicable to the films and/or coatings produced from the electrically conductive polymer compositions.

As one of ordinary skill in the art would readily appreciate, the electrically conductive polymer compositions can comprise different amounts of the intrinsically conductive polymers in their wet and dried states based on the presence of the solvent. As a wet composition, the electrically conductive polymer compositions can comprise at least about 0.1, 0.25, 0.40, or 0.48 and/or not more than about 20, 10, 4, or 1 mass percent of one or more intrinsically conductive polymers on a dry basis. More particularly, the electrically conductive polymer compositions as a wet composition can comprise in the range of about 0.1 to 20, 0.25 to 10, 0.40 to 4, or 0.48 to 1 mass percent of one or more intrinsically conductive polymers on a dry basis. In certain embodiments, the electrically conductive polymer compositions as a wet composition can comprise about 0.92% mass percent of the intrinsically conductive polymer on a dry basis. It should be noted that these above mass percentages take into account the addition of the solvent and can vary depending on the amount and type of solvent used. Thus, the mass percentages could further vary with the addition of the additives discussed below and will change with the evaporation of the solvent.

The dried electrically conductive compositions can comprise at least about 0.5, 1, 2, or 4 and/or not more than about 50, 25, 10, or 7 mass percent of one or more intrinsically conductive polymers on a dry basis. More particularly, the dried electrically conductive polymer compositions can comprise in the range of about 0.5 to 50, 1 to 25, 2 to 10, or 4 to 7 mass percent of one or more intrinsically conductive polymers on a dry basis.

The intrinsically conductive polymer can be supplied as a waterborne dispersion. Other components can also be included in the dispersion, including, for example, chemical actives to increase the conductivity, film formers, heat and light stabilizers, and organic co-solvents. Although the intrinsically conductive polymer can be supplied as an aqueous dispersion and can include these other components, the mass percentages of intrinsically conductive polymer referenced above and in the examples are mass percentages for the intrinsically conductive polymer alone and do not include the other possible components in the dispersion. Furthermore, the above mass percentages for the intrinsically conductive polymers are on a dry basis and do not account for the water in the dispersions. These waterborne dispersions can comprise, for example, in the range of about 50 to 99 mass percent of water.

### UV Curable Resins

The electrically conductive polymer compositions described herein can comprise at least one UV curable resin.

The UV curable resins can be a monomer and/or oligomer and can be utilized in UV initiated curing. The UV curable resins in the compositions can increase the stiffness of the films produced therefrom, but can still provide a certain amount of flexibility. Furthermore, the UV curable resins can also advantageously improve the solvent resistance of the films and/or coatings produced from the electrically conductive polymer compositions.

Examples of suitable UV curable monomers for use in the compositions can include diacrylates, polyacrylates, or a mixture thereof. Specific UV curable monomers can include, but are not limited to, pentaerythritol triacrylate; pentaerythritol tetraacrylate; 3-methyl-1,5-pentanediyl diacrylate; neopentyl glycol propoxylate (2) diacrylate; and tricyclododecane dimethanol diacrylate. In certain embodiments, the electrically conductive polymer compositions can comprise a pentaerythritol triacrylate. It should be noted that other acrylates may be added and different amounts utilized depending on the compatibility and mechanical performance of the desired films, as would be recognized by one of ordinary skill in the art.

The wet electrically conductive polymer composition can comprise at least about 1, 5, 8, or 11 and/or not more than about 60, 30, 15, or 14 mass percent of at least one UV curable resin on a dry basis. More particularly, the wet electrically conductive polymer composition can comprise in the range of about 1 to 60, 5 to 30, 8 to 15, or 11 to 14 mass percent of at least one UV curable resin on a dry basis. As previously noted, these percentages can vary depending on the amount and type of solvent in the wet composition.

The dried electrically conductive polymer composition can comprise at least about 5, 10, 20, or 40 and/or not more than about 95, 90, 80, or 70 mass percent of at least one UV curable resin on a dry basis. More particularly, the dried electrically conductive polymer composition can comprise in the range of about 5 to 95, 10 to 90, 20 to 80, or 40 to 70 mass percent of at least one UV curable resin on a dry basis.

Furthermore, it has been observed that the Monomer-Polymer Ratio can greatly affect the conductivity properties of the films and/or coatings produced from the electrically conductive polymer compositions. The “Monomer-Polymer Ratio” refers to the ratio of the UV curable resin to the intrinsically conductive polymer. The Monomer-Polymer Ratio can be obtained by dividing the volume of the UV curable resin in the dried composition by the volume of the intrinsically conductive polymer. The following equation shows how the Monomer-Polymer Ratio is calculated:

$$Monomer \text{-} Polymer Ratio = \frac{{Mass}_{UV Cured Resin} / Specific {Gravity}_{UV Cured Resin}}{{Mass}_{ICP} / Specific {Gravity}_{ICP}}$$

The wet and/or dried electrically conductive polymer composition can have a Monomer-Polymer Ratio of at least about 1:1, 2:1, 5:1, 10:1, or 18:1 and/or not more than about 50:1, 45:1, 40:1, 35:1, or 30:1. More particularly, the wet and/or dried electrically conductive polymer composition can have a Monomer-Polymer Ratio in the range of about 1:1 to 50:1, 2:1 to 45:1, 5:1 to 40:1, 10:1 to 35:1, or 18:1 to 30:1.

### Solvents

The electrically conductive polymer compositions described herein can comprise at least one solvent. It should be noted that this solvent does not include the water present in the waterborne dispersions containing the intrinsically conductive polymers.

The solvent can be added both to increase the conductivity of the resultant film and to aid in the application of the wet composition. Generally, all or essentially all of the solvent can evaporate upon subjecting the wet composition to drying and/or curing.

In various embodiments, the electrically conductive polymer compositions can include at least one high boiling point solvent having a boiling point above 100° C. and at least one low boiling point solvents having a boiling point below 100° C. In other embodiments, the electrically conductive polymer compositions can include either the high boiling point solvent or the low boiling point solvent. The high boiling point solvents can increase the conductivity of the resulting films, while the low boiling point solvents can facilitate the application of the wet composition since they evaporate more readily.

Solvents that may be used include, but are not limited to, dimethyl sulfoxide, ethanol, methanol, methyl isobutyl ketone, ethyl acetate, diacetone alcohol, methyl ethyl ketone, methyl n-propyl ketone, n-methyl pyrrolidone, isopropyl alcohol, n-butyl acetate, and combinations thereof. Various high boiling point solvents can include, for example, dimethyl sulfoxide, methyl isobutyl ketone, diacetone alcohol, methyl n-propyl ketone, n-methylpyrrolidone, and n-butyl acetate. Low boiling point solvents can include, for example, ethanol, methanol, ethyl acetate, methyl ethyl ketone, and isopropyl alcohol. In various embodiments, the solvents can comprise a polar and/or a protic solvent. The choice of solvents can depend upon the solvents' effects on wetting, conductivity, and formulation compatibility.

The wet electrically conductive polymer compositions can comprise at least about 1, 10, 25, or 45 and/or not more than about 95, 80, 70, or 65 mass percent of one or more solvents. More particularly, the wet electrically conductive polymer compositions can comprise in the range of about 1 to 95, 10 to 80, 25 to 70, or 45 to 65 mass percent of one or more solvents. Due to drying and/or curing steps described below, the dried compositions generally can contain less than about 1, 0.1, or 0.001 mass percent of the solvent.

In various embodiments, the wet electrically conductive polymer compositions can comprise at least about 0.5, 1, 5, or 10 and/or not more than about 95, 75, 60, or 40 mass percent of the high boiling point solvent. More particularly, the wet electrically conductive polymer compositions can comprise in the range of about 0.5 to 95, 1 to 75, 5 to 60, or 10 to 40 mass percent of the high boiling point solvent. Additionally or alternatively, the wet electrically conductive polymer compositions can comprise at least about 0.5, 1, 5, or 10 and/or not more than about 95, 75, 60, or 40 mass percent of the low boiling point solvent. More particularly, the wet electrically conductive polymer compositions can comprise in the range of about 0.5 to 95, 1 to 75, 5 to 60, or 10 to 40 mass percent of the low boiling point solvent. In one or more embodiments, the wet electrically conductive polymer compositions can comprise a ratio of high boiling point solvent to low boiling point solvent of at least about 0.01:1, 0.1:1, or 0.5:1 and/or not more than about 100:1, 50:1, or 10:1. More particularly, the wet electrically conductive polymer compositions can comprise a ratio of high boiling point solvent to low boiling point solvent in the range of 0.01:1 to 100:1, 0.1:1 to 50:1, or 0.5 to 10:1.

### Photoinitiators

The electrically conductive polymer compositions described herein can comprise at least one photoinitiator. In various embodiments, the photoinitiators can be at least partially soluble in the solvent at the processing temperature of the intrinsically conductive polymer. The photoinitiators can also be substantially colorless after being polymerized. In some embodiments, the photoinitiator may be colored (e.g., yellow); however, it can generally be rendered substantially colorless after exposure to the UV light source in such embodiments.

The photoinitiators described herein can include, for example, diphenyl (2,4,6-trimethylbenzoyl)-phosphine oxide; 2-hydroxy-2-methyl-1-phenyl-1-propanone; a 1:1 mixture of the two preceding photoinitiators; 1-hydroxy-cyclohexyl-phenyl-ketone; benzphenone; and phenylglyoxylate. Other selected photoinitiators may be added and different amounts utilized as required for photoinitiation of the UV curable resins.

The wet electrically conductive polymer compositions can comprise at least about 0.01, 0.1, 0.5, or 1.0 and/or not more than about 20, 10, 5, or 3 mass percent of one or more photoinitiators on a dry basis. More particularly, the wet electrically conductive polymer compositions can comprise in the range of about 0.01 to 20, 0.1 to 10, 0.5 to 5, or 1 to 3 mass percent of one or more photoinitiators on a dry basis. In certain embodiments, the wet electrically conductive polymer compositions can comprise about 1.35 mass percent of one or more photoinitiators. More or less photoinitiators can be employed depending on the specific requirements for the electrically conductive polymer compositions, such as color and cure speed.

The dried electrically conductive polymer compositions can comprise at least about 0.1, 1, 3, or 5 and/or not more than about 30, 20, 10, or 8 mass percent of one or more photoinitiators on a dry basis. More particularly, the dried electrically conductive polymer compositions can comprise in the range of about 0.1 to 30, 1 to 20, 3 to 10, or 5 to 8 mass percent of one or more photoinitiators on a dry basis.

Furthermore, the electrically conductive polymer compositions can comprise at least about 0.1, 1, or 2 and/or not more than 50, 35, or 25 parts of photoinitiator per 100 parts of UV curable resin. More particularly, the electrically conductive polymer compositions can comprise in the range of about 0.1 to 50, 1 to 35, or 2 to 25 parts of photoinitiator per 100 parts of UV curable resin.

### Other Additives

The electrically conductive polymer compositions described herein can also include various other additives. For example, these additives can include surfactants and water. The use of surfactants can lower the surface tension of the composition thereby improving its wettability. In such embodiments, the surfactants can act as wetting agents. Such surfactants can include long chain alcohols such as, for example, ethoxylated 2,5,8,11-tetramethyl-6-dodecyne-5,8-diol 2-hydroxy-2-methyl-1-phenylapropan-1-one and sodium laureth sulfate. Other surfactants may be added and different amounts utilized depending on the desired wettability of the film, as would be recognized by one of ordinary skill in the art.

The wet electrically conductive polymer compositions can comprise at least about 0.01, 0.1, or 0.5 and/or not more than about 20, 10, or 5 mass percent of one or more surfactants on a dry basis. More particularly, the wet electrically conductive polymer compositions can comprise in the range of about 0.01 to 20, 0.1 to 10, or 0.5 to 5 mass percent of one or more surfactants on a dry basis.

The dried electrically conductive polymer compositions can comprise at least about 0.1, 0.5, or 1 and/or not more than about 20, 10, or 5 mass percent of one or more surfactants on a dry basis. More particularly, the dried electrically conductive polymer compositions can comprise in the range of about 0.1 to 20, 0.5 to 10, or 1 to 5 mass percent of one or more surfactants on a dry basis.

Furthermore, the wet electrically conductive compositions can comprise water. This water can be added separately and/or can consist of the water originally present in the waterborne dispersions containing the intrinsically conductive polymers that are added to form the wet electrically conductive composition. The wet electrically conductive compositions can comprise at least about 5, 15, or 30 and/or not more than about 80, 60, or 40 mass percent of water. More particularly, the wet electrically conductive compositions can comprise in the range of 5 to 80, 15 to 60, or 30 to 40 mass percent of water.

### Methods of Forming Films and Coatings

The electrically conductive polymer compositions described herein can be used to produce films and coatings. As noted above, the intrinsically conductive polymers are typically supplied as predominantly waterborne dispersions with minor amounts of surfactants, stabilizers, and organic co-solvents. Because some of these components are generally thought to be incompatible, the preparation and application of the films and coatings have to be carried out in a way that does not destabilize the dispersion of the electrically conducting polymers. Maintaining dispersion stability compatibility of all the ingredients can be essential to avoid generating excessive haze, and thereby a loss of clarity and light transmission, that occurs when the particle size of the dispersed phase becomes large enough to scatter visible light (i.e., when the emulsion crashes). Thus, the specific amounts of the individual components and the method of preparation (e.g., gradually diluting the dispersion with the solvent) can be very important in maintaining this compatibility.

The electrically conductive polymer compositions can be applied to a surface as a “coating” to form a “layer” over an underlying surface. Once dried and in final form, this “coating” or “layer” is commonly called a “film.” In this regard, the terms “coating,” “layer,” and “film” can be used interchangeably herein. The films can cover a desired area of any size. The area can be as large as an entire electronic device's visual display or as small as a single sub-pixel.

The coating can be applied by any conventional deposition technique, including, but not limited to, chemical deposition, physical deposition, gravure, curtain or slot die coating methods, and the like in order to form the resultant film. Chemical deposition can include, for example, liquid and vapor deposition. The electrically conductive polymer compositions can be applied in an amount sufficient to provide a dry film of any desired thickness. In various embodiments, the films can have a thickness of at least about 0.001, 0.01, 0.1, or 1 and/or not more than about 1,000, 100, 3, or 2 μm. More particularly, the films can have a thickness in the range of 0.001 to 1,000, 0.01 to 100, 0.1 to 3, or 1 to 2 μm. The desired thickness can also vary depending on the curing technique. For example, when curing in a standard atmospheric air environment, it is generally advantageous to not have the thickness below about 1 micron. However, a lower thickness can be achieved if the coating is cured under inert conditions, e.g., under nitrogen.

After application, the coating composition can then be thermally dried and subjected to UV curing. The coating composition can be first dried in an oven at a temperature of about 260° F. for a total time of about two minutes. The coating composition can then be cured in an ultraviolet oven having an output of about 300 watts per inch. As noted above, at least one solvent can be added to aid in the application of the wet coating composition and all or essentially all the solvent evaporates upon drying. As used herein, “essentially all” means at least 90 percent by weight.

In various embodiments, the films and coatings produced from the electrically conductive polymer compositions can comprise at least about 25, 50, 75, or 95 and/or not more than about 99.9, 99, 98, or 97 mass percent of the intrinsically conductive polymer, UV curable resin, photoinitiator, and surfactants described herein. More particularly, the films and coatings produced from the electrically conductive polymer compositions can comprise in the range of about 25 to 99.9, 50 to 99, 75 to 98, or 95 to 97 mass percent of the intrinsically conductive polymer, UV curable resin, photoinitiator, and surfactants described herein.

The films described herein can be used in electronic devices where a wide variety of the resistivity values, low haze values, and high visible light transmission are all desired. In some embodiments, the films can be used as electrodes; in others, as transparent conductive coatings. In this latter application, the films can be applied to transparent substrates such as glass or flexible films such as polyethylene terephthalate (“PET”), polyethylene naphthalate (“PEN”), cellulose esters, acrylics, polycarbonates, cyclic olefin copolymers and the like. It should be noted that the “flexible films” are different from the specific films described herein, and one of ordinary skill in the art would readily recognize the difference between a flexible film substrate and the film coatings described herein.

Examples of electronic devices that may contain one or more of the electrically conductive polymer films described herein include, but are not limited to, light emitting diode displays (including organic LEDs), electroluminescent displays, electronic paper displays, photodetectors, IR detectors, touchscreen devices, and photovoltaic assemblies.

It should be noted, however, that while the films are often specifically discussed for use in electronic devices in this application, it would be understood by one of ordinary skill that numerous other applications are appropriate. For example, the composition could be utilized as a coating material for memory storage devices, antistatic films, batteries, lighting sources, and the like. These additional uses are merely exemplary and are in no way limiting. Accordingly, it should be understood that when use as a film for electronic devices is described herein, other uses may also apply, as would be known to one of ordinary skill in the art.

### Properties of the Electrically Conductive Polymer Compositions

The electrically conductive polymer compositions described herein can improve the flexibility of the resulting films and the resistance of the films to various chemicals and weathering while still maintaining desired levels of wettability, electrical resistance/conductance, clarity (measured as haze), and visible light transmission. This improved performance can be accomplished with the use of the intrinsically conductive polymers and UV curable monomers. Furthermore, since these films do not require conductive metals or carbon black, the resulting films can be produced more efficiently and at a lower cost.

As previously noted, the electrically conductive polymer compositions and films produced therefrom can exhibit significantly improved wettability and resistance to chemicals such as alcohols, water, soaps, and organic solvents. As used herein, “wetting” refers to the ability of a liquid to maintain contact with a solid surface resulting from intermolecular interactions when the two are brought together. The degree of wetting (“wettability”) is determined by a force balance between adhesive and cohesive forces. Wettability scores were assessed visually and ranked based on a scale of 0 to 5. A score of 5 denotes a sample that has 100% wetting; a score of 4 denotes a sample that has at least 80% wetting but less than 99%; a score of 3 denotes a sample that has at least 60% wetting but less than 80%; a score of 2 denotes a sample that has at least 40% wetting but less than 60%; a score of 1 denotes a sample having at least 20% wetting but less than 40%; and a score of 0 denotes a sample that has at least 0% wetting but less than 20%. In various embodiments, films produced from the electrically conductive polymer compositions can have a wetting score in the range of 2 to 5, 3 to 5, or 4 to 5.

The solvent resistance of the films produced from the electrically conductive polymer compositions is measured with the solvent abrasion test in accordance with AATCC Test Method 165. The solvent abrasion test utilizes an Atlas Textile Testing Products CM-5 Crockmeter having a cycling arm weighted with a known load of approximately 900 grams applied over an abrading surface having a diameter of 2 centimeters. Four cloth pads are attached to the abrasion head located on the tip of the arm of the crockmeter. The pads are then soaked with a mixture of 80% isopropyl alcohol and 20% deionized water by weight, although any liquid composition could suffice. The arm's force is applied to the conductive side of the film and 100 cycles (with each cycle composed of an oscillatory forward and return stroke) are then carried out. The crockmeter is stopped after every 25 cycles and the samples are visually evaluated for coating removal.

The “electrical surface resistivity” measures the opposition to the passage of an electric current through a square portion (of any size) of the films and is calculated as ohms per square (“Ω/square”). This value is obtained by using an R-Check RC2175 4-point sheet resistance meter (R-Check). The films and coatings produced from the electrically conductive polymer compositions described herein can have resistivity values of at least about 100, 250, 500, or 750 and/or not more than about 3,000,000, 100,000, 10,000, or 3,000 Ω/square. More particularly, the films and coatings produced from the electrically conductive polymer compositions can have resistivity values ranging from about 100 to 3,000,000, 250 to 100,000, 500 to 10,000, 500 to 3,000, or 750 to 3,000 Ω/square. In certain embodiments, the films and coatings produced from the electrically conductive polymer compositions can have resistivity values of less than about 3000 Ω/square, less than about 2000 Ω/square, or less than about 1000 Ω/square.

The sheet resistivity of several locations on the film samples are recorded and measured before and after the solvent abrasion test. The recorded resistivities are averaged and subtracted to determine the average change in resistivity from the chemical abrasion in the solvent abrasion test. The films and coatings produced from the electrically conductive polymer compositions can exhibit changes in resistance (“ΔΩ/square”) of less than about 50, 20, 10, 5, 4, or 3 percent after being subjected to the solvent abrasion test. The smaller change in resistivity can indicate that the resulting film or coating exhibits an improved solvent resistance.

Another parameter used to describe the films disclosed herein is clarity, which is determined by measuring the haze value or percent haze. Light that is scattered upon passing through a film or sheet of a material can produce a hazy or smoky field when objects are viewed through the material. Thus, the haze value is a quantification of the scattered light by a sample in contrast to the incident light. The test for percent haze is performed with a hazemeter, such as the HunterLab UltraScan® PRO, and in accordance with ATSM D1003-61 (Re-approved 1977)-Procedure A using Illuminant C, at an observer angle of 2 degrees. The films and coatings produced from the electrically conductive polymer compositions can have a percent haze of less than about 40, 25, 5, 3, or 2 percent.

The visible light transmission is the percent of total visible light that is transmitted through the composite film system. The lower the number, the less visible light transmitted. The visible light transmission is calculated using CIE Standard Observer (CIE 1924 1931) and D65 Daylight on a spectrophotometer such as the HunterLab UltraScan® PRO. The films and coatings produced from the electrically conductive polymer compositions can have a visible light transmission of greater than about 25, 50, 85, or 88 percent.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

This invention can be further illustrated by the following examples of embodiments thereof, although it will be understood that these examples are included merely for the purposes of illustration and are not intended to limit the scope of the invention unless otherwise specifically indicated.

### EXAMPLES

### Examples 1-10

Varying amounts of intrinsically conductive polymer (PEDOT-PSS) (CLEVIOS from Heraseus); photoinitiator (a 1:1 mixture of diphenyl (2,4,6-trimethylbenzoyl)-phosphine oxide and 2-hydroxy-2-methyl-1-phenyl-1-propanone) (Darocur 4265 from BASF); and UV curable resin (pentaerythritol triacrylate) (Sartomer SR 444 from Sartomer) were all mixed together with varying amounts of solvents (dimethyl sulfoxide and ethanol mixture from Gaylord Chemical) to form the wet compositions shown below in Table 1 (Samples 1-10). All values given in Table 1 are mass percentages. As noted above, the intrinsically conductive polymer is generally supplied as a dispersion in water (amongst other components), but the mass percentages below are for the intrinsically conductive polymer alone. Water and other minor additives in the PEDOT-PSS dispersion, which are not listed in Table 1, made up the remaining mass percentage in each of the samples.

The wet samples were applied to a polyethylene terephthalate (PET) film and dried in an oven at a temperature of 260° F. for 2 minutes. The samples were then cured in an ultraviolet oven having an output of 300 watts per inch to form dry films with the below listed thicknesses (in microns).

TABLE 1

| | Intrinsically | | UV | | | Thick- |
|---|---|---|---|---|---|---|
| | Conductive | Photo- | Curable | Dimethyl | | ness |
| Sample | Polymer | initiator | Resin | Sulfoxide | Ethanol | (μm) |
| 1 | 1.5784 | 1.35 | 8.97 | 7.17 | 43.05 | 0.55 |
| 2 | 1.4816 | 1.68 | 14.14 | 6.73 | 40.40 | 0.57 |
| 3 | 1.4916 | 1.02 | 14.24 | 6.78 | 40.68 | 0.63 |
| 4 | 0.9004 | 1.35 | 13.10 | 9.00 | 54.03 | 1.63 |
| 5 | 0.9004 | 1.35 | 13.10 | 9.00 | 54.03 | 1.53 |
| 6 | 0.9176 | 1.38 | 11.47 | 9.17 | 55.05 | 0.88 |
| 7 | 0.9176 | 1.38 | 11.47 | 9.17 | 55.05 | 1.28 |
| 8 | 0.9124 | 1.37 | 11.95 | 9.12 | 54.74 | 1.07 |
| 9 | 0.9176 | 1.38 | 11.47 | 9.17 | 55.05 | 1.30 |
| 10 | 0.9048 | 2.71 | 11.31 | 9.05 | 54.30 | 1.60 |

Samples 1-10 were then tested for visible light transmission (%), haze (%), resistivity (Ω/□), and change in resistivity after being subjected to the solvent abrasion test. The results of these tests are shown below in Table 2.

TABLE 2

| | Visible Light | Haze | Resistivity | Change in |
|---|---|---|---|---|
| Sample | Transmission (%) | (%) | (Ω/□) | Resistivity |
| 1 | 89.10 | 1.76 | 1320.67 | −49.98 |
| 2 | 89.50 | 1.26 | 2149.38 | −33.74 |
| 3 | 88.90 | 1.22 | 1586.00 | −33.86 |
| 4 | 88.20 | 1.40 | 973.13 | 10.00 |
| 5 | 88.20 | 1.40 | 906.92 | 9.03 |
| 6 | 88.30 | 1.51 | 1350.00 | −1.85 |
| 7 | 88.30 | 1.51 | 942.86 | −0.58 |
| 8 | 90.00 | 1.81 | 1081.54 | −5.31 |
| 9 | 88.30 | 1.20 | 1138.46 | 6.63 |
| 10 | 86.94 | 2.70 | 735.45 | 4.55 |

As can be seen, Samples 1-10 all have desirable levels of visible light transmission, haze, and resistivity. In particular, Tables 1 and 2 demonstrate that the thickness of the film, the intrinsically conductive polymer concentration, the UV curable resin concentration, and the ratio of intrinsically conductive polymer to UV curable resin can affect the solvent resistance of the samples as indicated by their changes in resistivity. For example, when compared to the other samples, Sample 1 has a high concentration of intrinsically conductive polymer, a low concentration of UV curable resin, and a low dry film thickness. In contrast, Sample 2 has a high concentration of intrinsically conductive polymer, a high concentration of UV curable resin, and a low dry film thickness. Samples 4 and 5 have low concentrations of intrinsically conductive polymer, high concentrations of UV curable resin, and high dry film thicknesses. Despite these differences, Samples 1, 2, 4, and 5 all exhibited desirable solvent resistances as indicated by their relatively low changes in resistivity. However, Tables 1 and 2 do appear to suggest that the solvent resistance can be increased somewhat by increasing the thickness of the dry film and the UV curable resin concentration as shown in Samples 4 and 5.

### Example 11

A wet sample was prepared by combining 585 grams of a PEDOT-PSS dispersion (CLEVIOS from Heraseus); 1551 grams of dimethyl sulfoxide (Gaylord Chemical); 1042.2 grams of diacetone alcohol (Fisher Scientific); 72 grams of 2-hydroxy-2-methyl-1-phenylpropan-1-one and 2,4,6-[trimethylbenzoyldiphenylphoshine]oxide (Darocur 4265 from BASF); 5.85 grams of ethoxylated 2,5,8,11-tetramethyl-6-dodecyne-5,8-diol (Dynol 604 from Air Products); and 351 grams of pentaerythritol triacrylate (Sartomer SR 444 from Sartomer) were added in the stated order in a clean pain while mixing. To ensure homogeneity, the dispersion was mixed for an additional 30 minutes after the pentaerythritol triacrylate was added. The dispersion was deposited onto a 24″ wide, 5 mil thick, heat stabilized, surface treated ST504 polyester film manufactured by DuPont Teijin Films, using a 55 tetrahedral cylinder while the film passed along at 40 feet per minute (20 percent overspeed). The film was thermally dried at 260° F. in a 15 foot long thermal oven and cured in a 15 foot long ultraviolet oven having an output of 300 watts per inch, resulting in a dry film having a thickness of 1.76 microns (excluding the thickness of the underlying ST504 film). Both the standard ST504 film and the sample film were then checked for visible light transmission (%), haze (%), resistivity (Ω/□), and change in resistivity after being subjected to the solvent abrasion test. The results of these tests are shown below in Table 3.

TABLE 3

| | Visible Light | Haze | Resistivity | Change in |
|---|---|---|---|---|
| Sample | Transmission (%) | (%) | (Ω/□) | Resistivity |
| 11 | 88.01 | 0.8 | 1655.75 | 2.55 |
| ST504 | 88.32 | 0.7 | N/A | N/A |

As can be seen, Sample 11 has a similar visible light transmission and haze values as the ST504 polyester film. Sample 11 also has a very low resistivity and change in resistivity after being subjected to the solvent abrasion test.

### Examples 12-15

Varying amounts of intrinsically conductive polymer (PEDOT-PSS) (CLEVIOS from Heraseus); photoinitiator (a 1:1 mixture of diphenyl (2,4,6-trimethylbenzoyl)-phospine oxide and 2-hydroxy-2-methyl-1-phenyl-1-propanone) (Darocur 4265 from BASF); surfactant (ethoxylated 2,5,8,11-tetramethyl-6-dodecyne-5,8-diol 2-hydroxy-2-methyl-1-phenylapropan-1-one) (Dynol 604 from Air Products); and UV curable resin (pentaerythritol triacrylate) (Sartomer SR 444 from Sartomer) were all mixed together with varying amounts of solvents (dimethyl sulfoxide and diacetone alcohol from Gaylord Chemical) to form the compositions shown below in Table 4 (Samples 12-15). All values given are mass percentages. As noted above, the intrinsically conductive polymer is generally supplied as a dispersion in water (among other components), but the mass percentages below are for the intrinsically conductive polymer alone. Water and other minor additives in the PEDOT-PSS dispersion, which are not listed in Table 4, made up the remaining mass percentage in each of the samples.

The compositions were then applied to a polyethylene terephthalate (“PET”) film and dried in an oven at a temperature of 260° F. for 2 minutes. The samples were then cured in an ultraviolet oven having an output of 300 watts per inch to thereby form dry films with thicknesses of about 2 microns.

TABLE 4

| | Intrinsically | | UV | | | |
|---|---|---|---|---|---|---|
| Sam- | Conductive | Photo- | Curable | Dimethyl | Diacetone | Sur- |
| ple | Polymer | initiator | Resin | Sulfoxide | Alcohol | factant |
| 12 | 0.694848 | 0.2895 | 14.4760 | 40.5327 | 27.1569 | 0.1737 |
| 13 | 0.616968 | 0.3085 | 15.4242 | 41.1311 | 27.5578 | 0.1542 |
| 14 | 0.554784 | 0.3236 | 16.1812 | 41.6089 | 27.8779 | 0.1387 |
| 15 | 0.503988 | 0.3360 | 16.7997 | 41.9992 | 28.1394 | 0.1260 |

Samples 12-15 were then tested for resistivity (Ω/□) and change in resistivity (%-ΔΩ/□) after being subjected to the solvent abrasion test described above. Additionally, the Monomer-Polymer Ratio (i.e., the volume ratio of UV curable monomer to volume of intrinsically conductive polymer) was determined for each sample. The “Monomer-Polymer Ratio” was obtained by dividing the volume fraction of UV curable monomer in the dry film by the volume fraction of intrinsically conductive polymer in the dry film—based on the following equation:

$$Monomer \text{-} Polymer Ratio = \frac{{Mass}_{UV Cured Resin} / Specific {Gravity}_{UV Cured Resin}}{{Mass}_{ICP} / Specific {Gravity}_{ICP}}$$

The results of these tests and calculations are shown below in Table 5.

TABLE 5

| | Resistivity | Change in | Monomer- |
|---|---|---|---|
| Sample | (Ω/□) | Resistivity | Polymer Ratio |
| 12 | 1,709 | 2440.61 | 18.04 |
| 13 | 87,237 | 501.67 | 21.65 |
| 14 | 987,290 | 309.03 | 25.25 |
| 15 | 2,851,000 | 102.58 | 28.86 |

As can be seen in Table 5, as the Monomer-Polymer Ratio increases, the change in resistivity decreases. Thus, as the Monomer-Polymer Ratio increases, so does the solvent resistance of the compositions.

### Examples 16-19

Samples 16-19 were formed from a single composition that was produced by combining about 1 mass percent intrinsically conductive polymer (PEDOT-PSS) (CLEVIOS from Heraseus); less than about 2 mass percent photoinitiator (a 1:1 mixture of diphenyl (2,4,6-trimethylbenzoyl)-phospine oxide and 2-hydroxy-2-methyl-1-phenyl-1-propanone) (Darocur 4265 from BASF); less than about 1 mass percent surfactant (ethoxylated 2,5,8,11-tetramethyl-6-dodecyne-5,8-diol 2-hydroxy-2-methyl-1-phenylapropan-1-one) (Dynol 604 from Air Products); and about 11 mass percent UV curable monomer (pentaerythritol triacrylate) (Sartomer SR 444 from Sartomer) with about 64 mass percent of solvent (9 mass percent dimethyl sulfoxide and 55 mass percent diacetone alcohol) (Gaylord Chemical). Water and other minor additives in the PEDOT-PSS dispersion made up the remaining mass percentage in each of the samples.

The compositions were then applied to a PET film and dried in an oven at a temperature of 260° F. for 2 minutes. The samples were then cured in an ultraviolet oven having an output of 300 watts per inch to form dry films with the below listed thicknesses (in microns). The samples were then tested for resistivity (Ω/□) and change in resistivity after being subjected to the solvent abrasion test described above. The results are shown below in Table 6.

TABLE 6

| | Dry Film | Resistivity | Change in |
|---|---|---|---|
| Sample | Thickness (μm) | (Ω/□) | Resistivity |
| 16 | 0.4376 | 14,390.00 | 172.90 |
| 17 | 0.6081 | 8,363.33 | 56.04 |
| 18 | 1.046 | 6,088.18 | 44.72 |
| 19 | 2.708 | 1,990.00 | 4.62 |

As can be seen in Table 6, as the thickness of the dry films increases, the sheet resistance and change in resistivity decreases. Thus, as the thickness of the dry films increases, so does the solvent resistance.

While the invention has been disclosed in conjunction with a description of certain embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

### DEFINITIONS

In order to facilitate a more comprehensive understanding of the electrically conductive polymer composition and associated films, it is important to have an understanding of the terms used herein and the properties and characteristics associated with the film. It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the term “about” means that the associated numeric value and/or range can vary by 10 percent from its recited value.

What is claimed is:

1. A film formed from an electrically conductive composition, said composition comprising:
an intrinsically conductive polymer;
a UV curable resin; and
a photoinitiator;
wherein said film exhibits a resistivity of less than 3,000 Ω/square,
wherein said film exhibits a change in resistance of less than about 10 percent after being subjected to a solvent abrasion test according to AATCC Test Method 165.

2. The film of claim 1, wherein said intrinsically conductive polymer comprises poly(3,4-ethylenedioxythiophene)-poly(styrenesulfonate) (“PEDOT-PSS”).

3. The film of claim 1, wherein said composition comprises in the range of about 2 to 25 parts of said photoinitiator per 100 parts of said UV curable resin.

4. The film of claim 1, wherein said film exhibits a change in resistance of less than about 5 percent after being subjected to a solvent abrasion test according to AATCC Test Method 165.

5. A touchscreen device comprising said film of claim 1.

6. An electrically conductive composition, said composition comprising:
at least 0.1 and not more than 10 mass percent of an intrinsically conductive polymer;
at least 10 and not more than 80 mass percent of at least one solvent;
at least 1 and not more than 20 mass percent of a UV curable resin; and
a photoinitiator.

7. The composition of claim 6, wherein said composition has a Monomer-Polymer Ratio of at least about 5:1 and not more than about 50:1.

8. The composition of claim 6, wherein said intrinsically conductive polymer comprises poly(p-phenylene vinylene); poly(3,4-ethylenedioxythiophene); polyaniline; polyacetylene; poly(3,4-ethylenedioxythiophene)-poly(styrenesulfonate) (“PEDOT-PSS”), or a combination thereof.

9. The composition of claim 6, wherein said intrinsically conductive polymer comprises poly(3,4-ethylenedioxythiophene)-poly(styrenesulfonate) (“PEDOT-PSS”).

10. The composition of claim 6, wherein said composition comprises at least about 0.25 and not more than about 4 mass percent of said intrinsically conductive polymer.

11. The composition of claim 6, wherein said UV curable resin comprises pentaerythritol triacrylate; pentaerythritol tetraacrylate; 3-methyl-1,5-pentanediyl diacrylate; neopentyl glycol propoxylate diacrylate; tricyclododecane dimethanol diacrylate; or mixtures thereof.

12. The composition of claim 6, wherein said solvent comprises a high boiling point solvent having a boiling point above 100° C. and a low boiling point solvent having a boiling point below 100° C.

13. The composition of claim 6, wherein said composition comprises at least about 25 and not more than about 70 mass percent of said solvent.

14. The composition of claim 6, wherein said solvent comprises dimethyl sulfoxide, ethanol, methanol, methyl isobutyl ketone, ethyl acetate, diacetone alcohol, methyl ethyl ketone, methyl n-propyl ketone, n-methyl pyrrolidone, isopropyl alcohol, and n-butyl acetate, or a combination thereof.

15. The composition of claim 6, wherein said composition comprises at least about 0.1 and not more than about 5 mass percent of a surfactant.

16. A film formed from an electrically conductive composition, said composition comprising:
an intrinsically conductive polymer;
a UV curable resin; and
a photoinitiator;
wherein said composition has a Monomer-Polymer Ratio of at least about 5:1 and not more than about 50:1,
wherein said film exhibits a resistivity of at least 100 and not more than 100,000 Ω/square.

17. The film of claim 16, wherein said intrinsically conductive polymer comprises poly(3,4-ethylenedioxythiophene)-poly(styrenesulfonate) (“PEDOT-PSS”).

18. The film of claim 16, wherein said composition comprises at least about 2 and not more than about 25 mass percent of said intrinsically conductive polymers.

19. The film of claim 16, wherein said composition comprises at least about 20 and not more than about 80 mass percent of said UV curable resin.

20. The film of claim 16, wherein said film exhibits a change in resistance of less than about 10 percent after being subjected to a solvent abrasion test according to AATCC Test Method 165.

21. The film of claim 16, wherein said film exhibits a percent haze of not more than about 40 percent as measured according to ASTM D1003-61 and a visible light transmission of at least about 85 percent.

22. The film of claim 16, wherein said film has a thickness of at least about 0.01 and not more than about 1,000 μm.

23. A touchscreen device comprising said film of claim 16.

24. A method for forming a film on a substrate, said method comprising:
(a) applying an electrically conductive composition on said substrate to form an initial coating, wherein said composition comprises an intrinsically conductive polymer, a solvent, a UV curable resin, and a photoinitiator; and
(b) curing at least a portion of said initial coating to form said film on said substrate,
wherein said composition has a Monomer-Polymer Ratio of at least about 5:1 and not more than about 50:1,
wherein said film exhibits a resistivity of at least 100 and not more than 100,000 Ω/square.

25. The method of claim 24, wherein said curing comprises drying said initial coating to form a dried coating and subjecting said dried coating to UV radiation to form said film.

26. The method of claim 24, wherein said intrinsically conductive polymer comprises poly(3,4-ethylenedioxythiophene)-poly(styrenesulfonate) (“PEDOT-PSS”).

27. The method of claim 24, at least 0.1 and less than 10 mass percent of an intrinsically conductive polymer.

28. The method of claim 24, wherein said film exhibits a change in resistance of less than about 10 percent after being subjected to a solvent abrasion test according to AATCC Test Method 165.

29. The method of claim 24, wherein said substrate comprises glass, polyethylene terephthalate, polyethylene naphthalate, cellulose esters, acrylics, polycarbonates, cyclic olefin copolymers, or a combination thereof.
